(19) United States
(12) Patent Application Publication
(10) Pub. No.: US 2024/0273462 A1
(43) Pub. Date: Aug. 15, 2024

(54) SMART ASSET MANAGEMENT FRAMEWORK

(71) Applicant: Dell Products L.P., Round Rock, TX (US)

(72) Inventors: Tousif Mohammed, Bangalore (IN); Bijan Kumar Mohanty, Austin, TX (US); Pushpa Kumar Marlapalli, Leander, TX (US); Hung Dinh, Austin, TX (US); Prince Mathew, Bangalore (IN); Mohith Medikonda, Andhra Pradesh (IN)

(73) Assignee: Dell Products L.P., Round Rock, TX (US)

(21) Appl. No.: 18/167,960

(22) Filed: Feb. 13, 2023

(51) Int. Cl. G06Q 10/087; G06Q 10/083

(52) U.S. Cl. CPC G06Q 10/087; G06Q 10/0838

(57) ABSTRACT

A computer-implemented method is provided. Historical data associated with operation of a plurality of computing entities is received. Inventory information is tracked based on the historical data, including discovering when new computing entities are added to the plurality of computing entities. Transaction information is tracked based on the historical data. Transaction information comprises information associated with transactions of the plurality of computing entities and with a volume of transactions. Cost information associated with the transactions of each computing entity, is tracked. Utilization information, comprising information relating to utilization of an infrastructure of each respective computing entity, is also tracked. A database is built comprising at least one of inventory, transaction, and cost information. An output is generated providing a report of information on one or more computing entities in the plurality of computing entities. The report of information is based on information contained in the database of information.

### FIELD

Embodiments of the disclosure generally relate to computer networks and more particularly to providing a framework configured to monitor computer resource usage and transactions, predicting a future volume of usage and transactions BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

Distributed computing systems provide computing environments where computing tasks and other components of computer work, such as that of information handling systems, are executed across multiple computing entities (e.g., computing devices, computing integration platforms, etc.), via a computer network. To a user, a distributed system might appear to be a single computing entity; however, distributed computing effectively spreads a service or services to a number of different computing entities. These computing entities performing the work can be configured in some arrangements to split up a given computing task, where the computing entities may be coordinated to complete the computing task more efficiently than if a single device or computing entity was completing the task. In other arrangements, specific computing entities, such as integration platforms, may be configured to provide specific types of services or features as part of an overall system implementation. For example, certain integration platforms may handle receiving orders, certain platforms may handle delivery logistics, and certain integration platforms may manage contracts and/or payments.

In some configurations of distributed computing, the computing network can be a cloud network infrastructure. Distributed computing and cloud computing both can be used to distribute or spread one or more services to different computing entities; however, distributed computing involves distributing tasks or services to different computing entities to help them all contribute to perform the same task, whereas cloud computing may provide a service like a specific software functionality or storage functionality for businesses to use on their own tasks. For example, with some types of cloud computing, highly scalable and flexible information technology capabilities are delivered as a service, such as infrastructures, platforms, applications, and/or storage space, to users via the internet.

With the increased use of cloud computing products such as software as a service (SaaS), platform as a service, (PaaS), and infrastructure as a service (IasS), businesses have many affordable and streamlined opportunities to use distributed computing to improve their products and operations. The users pay for these services and/or resources that they use, but users do not need to build infrastructure of their own. Many different types of computing jobs and tasks now use distributed and/or cloud computing, including but not limited to: telecommunications networks (including cellular networks and the fabric of the internet), graphical and video-rendering systems, multi-player video gaming systems, scientific computing, scientific simulations, travel reservations systems, supply chain management systems, distributed retail systems, multi-user videoconferencing systems, and blockchain systems, cryptocurrency systems.

### SUMMARY

The following presents a simplified summary in order to provide a basic understanding of one or more aspects of the embodiments described herein. This summary is not an extensive overview of all of the possible embodiments and is neither intended to identify key or critical elements of the embodiments, nor to delineate the scope thereof. Rather, the primary purpose of the summary is to present some concepts of the embodiments described herein in a simplified form as a prelude to the more detailed description that is presented later.

Every organization has its own integration needs to serve its customers. In some organizations, to help fulfill integration needs, business teams within an organization may use different integration platforms to host their integrations/services. To best optimize the use of multiple different integration platforms, it is advantageous if leadership of an organization has improved knowledge of the utilization of and cost spending on, each integration platform. In certain embodiments herein, one or more frameworks are provided, including but not limited to a smart asset management framework that can provide a total cost of ownership, to help provide various types of reports, alert, and notifications, to leadership, about the utilization and cost (including predicted future costs) of integration platforms and applications.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method. The computer-implemented method also comprises receiving, at a first predetermined interval, historical data associated with operation of a plurality of computing entities. The method also comprises tracking inventory information based on the historical data, the tracking comprising discovering when new computing entities are added to the plurality of computing entities, wherein tracking inventor information place at a second predetermined interval; tracking transaction information, wherein the tracking is based on the historical data, wherein the transaction information comprises information associated with transactions of the plurality of computing entities and comprises information associated with a volume of transactions, and where the tracking of transaction information takes place at a third predetermined interval; tracking cost information associated with the transactions of each computing entity, the tracking of cost information taking place at a fourth predetermined interval; tracking utilization information associated with each computing entity, the utilization information comprising information relating to utilization of an infrastructure of each respective computing entity, the tracking of utilization information taking place at a fifth predetermined interval; building a database of information for each computing entity, the database comprising at last one of inventory, transaction, and cost information. The method also comprises generating an output providing a report of information on one or more computing entities in the plurality of computing entities, wherein the report of information is based on information contained in the database of information. Other embodiments of this aspect include corresponding computer systems, apparatus, and computer programs recorded on one or more computer storage devices, each configured to perform the actions of the methods.

Implementations may include one or more of the following features. In some embodiments, at least two of the first predetermined interval, second predetermined interval, third predetermined interval, fourth predetermined interval, and fifth predetermined interval, correspond to time intervals that are identical. In some embodiments, the second predetermined interval is configured so that inventory information is tracked in real time to ensure that the database of information is up to date. In some embodiments, the first predetermined interval is configured so that historical data is received before tracking transaction information, tracking cost information, and tracking utilization information. In some embodiments, the transaction information associated with transactions of the plurality of computing entities comprises at least one of usage, metrics, cost, capital expenses, infrastructure information, licensing information, and operating expenses.

In some embodiments, the report comprises a transaction cost metrics dashboard providing at least one of transaction information, cost information, and utilization information, for at least one computing entity of the plurality of computing entities. In some embodiments, the report is generated automatically based on information in the database and comprises at least one recommended action to optimize at least one of cost and efficiency associated with operation of at least one computing entity in the plurality of computing entities. In some embodiments, the report comprises at least one predicted transaction volume associated with at least one computing entity in the plurality of computing entities.

In some embodiments, the computer-implemented method further comprises: building a training dataset from a first subset of the historical data; building a testing dataset from a second subset of the historical data; performing first training of a machine learning regressor model, with the training dataset, to learn transaction volumes associated with the plurality of computing entities; performing a second training of the machine learning regressor model, with the testing dataset, to validate the machine learning regressor model; and generating the predicted transaction volume using the machine learning regressor model. Implementations of the described techniques may include hardware, a method or process, or computer software on a computer-accessible medium.

One general aspect includes another computer-implemented method. The computer-implemented method also comprises receiving historical data associated with operation of a plurality of computing entities; building a training dataset from a first subset of the historical data; building a testing dataset from a second subset of the historical data; performing first training of a machine learning regressor model, with the training dataset, to learn transaction volumes associated with the plurality of computing entities; performing a second training of the machine learning regressor model, with the testing dataset, to validate the machine learning regressor model; and predicting a transaction volume for at least one computing entity of the plurality of computing entities using the machine learning regressor model. Other embodiments of this aspect include corresponding computer systems, apparatus, and computer programs recorded on one or more computer storage devices, each configured to perform the actions of the methods.

Implementations may include one or more of the following features. In some embodiments, the computer-implemented method wherein the historical data comprises a plurality of features associated with each of a plurality of transactions and further comprising: determining in in the plurality of features, a first set of features that are correlated with predicting transaction volume and a second set of features that are irrelevant to predicting transaction volume; and configuring at least one of the testing dataset and the training dataset to remove points in the respective dataset that correspond to the second set of features. In some embodiments, the machine learning regressor model is configured using multiple regressors, wherein each of the multiple regressors is trained on different samples of data from the historical data. In some embodiments, the machine learning regressor model is configured using multiple regressors, wherein each of the multiple regressors is trained on different features of data from the historical data. In some embodiments, the machine learning regressor model implements a random forest regressor structure. In some embodiments, the machine learning regressor model implements ensemble bagging. Implementations of the described techniques may include hardware, a method or process, or computer software on a computer-accessible medium.

One general aspect includes a system. The system also comprises a processor; and a non-volatile memory in operable communication with the processor and storing computer program code that when executed on the processor causes the processor to execute a process operable to perform operations of: receiving, at first predetermined intervals, historical data associated with operation of a plurality of computing entities; tracking inventory information based on the historical data, the tracking comprising discovering when new computing entities are added to the plurality of computing entities, wherein tracking inventor information place at second predetermined intervals; tracking transaction information, wherein the tracking is based on the historical data, wherein the transaction information comprises information associated with transactions of the plurality of computing entities and comprises information associated with a volume of transactions, and where the tracking of transaction information takes place at third predetermined intervals; tracking cost information associated with the transactions of each computing entity, the tracking of cost information taking place at fourth predetermined intervals; tracking utilization information associated with each computing entity, the utilization information comprising information relating to utilization of an infrastructure of each respective computing entity, the tracking of utilization information taking place at a fifth predetermined interval; building a database of information for each computing entity, the database comprising at last one of inventory, transaction, and cost information; and generating an output providing a report of information on one or more computing entities in the plurality of computing entities, wherein the report of information is based on information contained in the database of information. Other embodiments of this aspect include corresponding computer systems, apparatus, and computer programs recorded on one or more computer storage devices, each configured to perform the actions of the methods.

Implementations may include one or more of the following features. In some embodiments, the computer program code is further configured, when executed on the processor, to cause the processor to execute a process operable to perform an operation of generating the report automatically based on information in the database, wherein the report comprises at least one recommended action to optimize at least one of cost and efficiency associated with operation of at least one computing entity in the plurality of computing entities. In some embodiments, the report comprises at least one predicted transaction volume associated with at least one computing entity in the plurality of computing entities.

In some embodiments, the computer program code is further configured, when executed on the processor, to cause the processor to execute a process operable to perform the operations of building a training dataset from a first subset of the historical data; building a testing dataset from a second subset of the historical data; performing first training of a machine learning regressor model, with the training dataset, to learn transaction volumes associated with the plurality of computing entities; performing a second training of the machine learning regressor model, with the testing dataset, to validate the machine learning regressor model; and generating a predicted transaction volume using the machine learning regressor model. In some embodiments, the machine learning regressor model is configured using multiple regressors, wherein each of the multiple regressors is trained on at least one of different samples of data from the historical data and different features of the data from the historical data. Implementations of the described techniques may include hardware, a method or process, or computer software on a computer-accessible medium.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims included herein.

Details relating to these and other embodiments are described more fully herein.

### BRIEF DESCRIPTION OF THE DRAWINGS

The advantages and aspects of the described embodiments, as well as the embodiments themselves, will be more fully understood in conjunction with the following detailed description and accompanying drawings, in which:

FIG. 1A is a simplified block diagram of an exemplary system implemented in accordance with one embodiment;

FIG. 1B is an exemplary architecture showing details of a framework for the exemplary system of FIG. 1A, in accordance with one embodiment;

FIG. 2 is an exemplary graphic showing exemplary infrastructure monitoring information determined using the exemplary system of FIG. 1A and exemplary architecture of FIG. 1i, in accordance with one embodiment;

FIG. 3 is an exemplary table showing software license monitoring determined using the exemplary system of FIG. 1A and the exemplary architecture of FIG. 1B, in accordance with one embodiment;

FIG. 4 is an exemplary transaction scheduler class diagram for a transaction scheduler used in the exemplary system of FIG. 1A and the exemplary framework architecture of FIG. 1B, in accordance with one embodiment;

FIG. 5 is an exemplary billing scheduler class diagram for a billing scheduler used in exemplary system of FIG. 1A and the exemplary framework architecture of FIG. 1B, in accordance with one embodiment;

FIG. 6 is a first high level exemplary flow diagram of a transaction prediction process of the exemplary system of FIG. 1A and the exemplary architecture of FIG. 1B, in accordance with one embodiment;

FIG. 7 is a second exemplary flow diagram of a transaction prediction process of the exemplary system of FIG. 1A and the exemplary architecture of FIG. 1B, showing further details of the process actions of FIG. 6, in accordance with one embodiment;

FIG. 8 is an exemplary table of sample data used to train a regression model for prediction, derived in accordance with the method of FIG. 7 and usable with the exemplary system of FIG. 1A and the exemplary architecture of FIG. 1B, in accordance with one embodiment;

FIG. 9 is an exemplary diagram of a Random Forest regressor structure used with embodiments of the exemplary system of FIG. 1A and the exemplary architecture of FIG. 1B, in accordance with one embodiment;

FIG. 10 is an exemplary representation of a user interface generated in accordance with the exemplary system of FIG. 1A and the exemplary architecture of FIG. 1B, in accordance with one embodiment;

FIG. 11A is an exemplary listing of sample code to achieve regression using Random Forest to predict the volume of transactions for the exemplary system of FIG. 1A and the exemplary architecture of FIG. 1B, in accordance with one embodiment;

FIG. 11B is an exemplary listing of sample code usable to split integration transaction data into training and testing sets, for the exemplary system of FIG. 1A and the exemplary architecture of FIG. 1B, in accordance with one embodiment;

FIG. 12 is an example listing of sample code usable for training a model using training data sets and testing accuracy of the model, for the exemplary system of FIG. 1A and the exemplary architecture of FIG. 1B, in accordance with one embodiment;

FIG. 13 is a simplified flowchart showing high level operations of the exemplary system of FIG. 1A and exemplary framework architecture of FIG. 1B, in accordance with one embodiment; and

FIG. 14 is a block diagram of an exemplary computer system usable with at least some of the systems, methods, examples, and outputs of FIGS. 1A-13, in accordance with one embodiment.

The drawings are not drawn to scale, emphasis instead being on illustrating the principles and features of the disclosed embodiments. In addition, in the drawings, like reference numbers indicate like elements.

### DETAILED DESCRIPTION

Before describing details of the particular systems, devices, arrangements, frameworks, and/or methods, it should be observed that the concepts disclosed herein include but are not limited to a novel structural combination of components and circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

Illustrative embodiments will be described herein with reference to exemplary computer and information processing systems and associated host devices, storage devices and other processing devices. It is to be appreciated, however, that embodiments are not restricted to use with the particular illustrative system and device configurations shown. For convenience, certain concepts and terms used in the specification are collected here. The following terminology definitions (which are intended to be broadly construed), which are in alphabetical order, may be helpful in understanding one or more of the embodiments described herein and should be considered in view of the descriptions herein, the context in which they appear, and knowledge of those of skill in the art.

“Cloud computing” is intended to refer to all variants of cloud computing, including but not limited to public, private, and hybrid cloud computing. In certain embodiments, cloud computing is characterized by five features or qualities: (1) on-demand self-service; (2) broad network access; (3) resource pooling; (4) rapid elasticity or expansion; and (5) measured service. In certain embodiments, a cloud computing architecture includes front-end and back-end components. Cloud computing platforms, called clients or cloud clients, can include servers, thick or thin clients, zero (ultra-thin) clients, tablets and mobile devices. For example, the front end in a cloud architecture is the visible interface that computer users or clients encounter through their web-enabled client devices. A back-end platform for cloud computing architecture can include single tenant physical servers (also called “bare metal” servers), data storage facilities, virtual machines, a security mechanism, and services, all built in conformance with a deployment model, and all together responsible for providing a service. In certain embodiments, a cloud native ecosystem is a cloud system that is highly distributed, elastic and composable with the container as the modular compute abstraction. One type of cloud computing is software as a service (SaaS), which provides a software distribution model in which a third-party provider hosts applications and makes them available to customers over a network such as the Internet. Other types of cloud computing can include infrastructure as a service (IaaS) and platform as a service (PaaS).

“Pivotal Cloud Foundry” (PCF) (also known in the art as “Cloud Foundry”) refers at least to an open source-agnostic Platform-as-a-Service (PaaS), available as a stand-along software PCF is an open source cloud platform as a service (PaaS) on which developers can build, deploy, run and scale applications. VMware originally created Cloud Foundry, and it is now part of Pivotal Software, whose parent company is Dell Technologies. PCF includes core components and functionality such as: routing, authentication, application lifecycle, application storage and execution, service brokers, messaging, metrics and logging. PCF provides a cloud-native ecosystem that supports a full application development lifecycle and allows developers to build, deploy, and run containerized applications. The Cloud Foundry operates using a container-based architecture to run, update, and deploy applications in any programming language over a variety of cloud service providers—public or private. Because PCF enables use of a multi-cloud environment, developers are able to move workloads between cloud providers as needed, without having to change an underlying application, so developers can choose cloud platforms that are optimal for specific application workloads.

“Computer network” refers at least to methods and types of communication that take place between and among components of a system that is at least partially under computer/processor control, including but not limited to wired communication, wireless communication (including radio communication, Wi-Fi networks, BLUETOOTH communication, etc.), cloud computing networks, telephone systems (both landlines and wireless), networks communicating using various network protocols known in the art, military networks (e.g., Department of Defense Network (DDN)), centralized computer networks, decentralized wireless networks (e.g., Helium, Oxen), networks contained within systems (e.g., devices that communicate within and/or to/from a vehicle, aircraft, ship, weapon, rocket, etc.), distributed devices that communicate over a network (e.g., Internet of Things), and any network configured to allow a device/node to access information stored elsewhere, to receive instructions, data or other signals from another device, and to send data or signals or other communications from one device to one or more other devices.

“Computer system” refers at least to processing systems that could include desktop computing systems, networked computing systems, data centers, cloud computing and storage systems, as well as other types of processing systems comprising various combinations of physical and virtual processing resources. A computer system also can include one or more desktop or laptop computers, and one or more of any type of device with spare processing capability. A computer system also may include at least one data center or other type of cloud-based system that includes one or more clouds hosting tenants that access cloud resources.

“Computing resource” at least refers to any device, endpoint, component, element, platform, cloud, data center, storage array, client, server, gateway, or other resource, which is part of an IT infrastructure associated with an enterprise.

“Enterprise” at least refers to one or more businesses, one or more corporations or any other one or more entities, groups, or organizations.

“Entity” at least refers to one or more persons, systems, devices, enterprises, and/or any combination of persons, systems, devices, and/or enterprises.

“Event Data” at least refers to actions that entities perform. Event data can include further information such as the action (the type of action performed, such as adding a file or document to a content management system), timestamp (the time when the action was performed) and state (all other relevant information known about the event, including but not limited to information about entities related to the event, such as a user/author and a particular application (e.g., content management system) associated with a user's action).

“Information processing system” as used herein is intended to be broadly construed, so as to encompass, at least, and for example, processing systems comprising cloud computing and storage systems, as well as other types of processing systems comprising various combinations of physical and virtual computing resources. An information processing system may therefore comprise, for example, a cloud infrastructure hosting multiple tenants that share cloud computing resources. Such systems are considered examples of what are more generally referred to herein as cloud computing environments, as defined above. Some cloud infrastructures are within the exclusive control and management of a given enterprise, and therefore are considered “private clouds.”

“Integration Platform” (IP) as used herein at least includes products that are configured to provide organizations with the integration tools they need to connect their systems, applications and data across their environment. IP at least refers to a cohesive set of integration software products that enable users to develop, secure and govern integration flows that connect diverse applications, systems, services and data stores.

“Internet of Things” (IoT) refers at least a broad range of internet-connected devices capable of communicating with other devices and networks, where IoT devices can include devices that themselves can process data as well as devices that are only intended to gather and transmit data elsewhere for processing. An IoT can include a system of multiple interrelated and/or interconnected computing devices, mechanical and digital machines, objects, animals or people that are provided with unique identifiers (UIDs) and the ability to transfer data over a network without requiring human-to-human or human-to-computer interaction. Even devices implanted into humans and/or animals can enable that human/animal to be part of an IoT.

“Log files” refer at least to files containing information about activities and actions that happen at certain times in a program, system, or other implementation, where the activities and actions include, but are not limited to, errors, transactions, events, and intrusions. Log files can include metadata that helps provide context to the information. Log files may have multiple types of formats, including but not limited to unstructured, semi-structured, and structured. My different types of entities can produce log files, including but not limited to programs, databases, storage systems, containers, firewalls and other security systems, gateways, routers, networks, IoT devices, endpoints, Web services, clients, servers, etc. Index logs (also known in the art as “log indexing”) provide an arrangement for log management, providing a structure that includes log management, where logs are arranged as keys based on some attributes, thereby sorting logs in to enable users to access them.

“Public Cloud” at least refers to cloud infrastructures that are used by multiple enterprises, and not necessarily controlled or managed by any of the multiple enterprises but rather are respectively controlled and managed by third-party cloud providers. Entities and/or enterprises can choose to host their applications or services on private clouds, public clouds, and/or a combination of private and public clouds (hybrid clouds) with a vast array of computing resources attached to or otherwise a part of such IT infrastructure.

“Transaction” at least refers to a set of computer instructions that satisfies the conditions of the ACID (atomic, consistent, isolated, and durable) property test, where a transaction can correspond to a group of related actions that are performed as a single action (such as the actions that take place to update a database), but where the transaction itself is considered to be an indivisible event.

“Transaction Data” refers at least to data associated with transactions, including success or failure of transactions, entities involved in the transaction, time of the transaction, etc. Transaction data can include data relating to many different types of events or actions that happen as transactions, including but not limited to data relating to:
generating, sending or receiving a message, alert, or other signal (e.g., an email message, error message, alert message, etc.);
performing an update to a database, document, file, etc.;
running a process, such as an entity running a process on itself or on another entity, such as a self-test or operational test, an error check, a scan for malware, a scan for changes, etc.;
generating and/or receiving documents related to a commercial sales transaction (e.g., sales order, purchase order, invoice, shipping document, etc.);
producing a file, set of data, or other information, for use by another entity, resource, program, or process.

Unless specifically stated otherwise, those of skill in the art will appreciate that, throughout the present detailed description, discussions utilizing terms such as “opening”, “configuring,” “receiving,”, “detecting,” “retrieving,” “converting”, “providing,”, “storing,” “checking”, “uploading”, “sending,”, “determining”, “reading”, “loading”, “overriding”, “writing”, “creating”, “including”, “generating”, “associating”, and “arranging”, and the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The disclosed embodiments are also well suited to the use of other computer systems such as, for example, optical and mechanical computers. Additionally, it should be understood that in the embodiments disclosed herein, one or more of the steps can be performed manually.

In addition, as used herein, terms such as “module,” “system,” “subsystem”, “engine,” “gateway,” “device,”, “machine”, “interface, and the like are intended to refer to a computer-implemented or computer-related in this application, the terms “component,” “module,” “system”, “interface”, “engine”, or the like are generally intended to refer to a computer-related entity or article of manufacture, either hardware, software, a combination of hardware and software, software, or software in execution. For example, a module includes but is not limited to, a processor, a process or program running on a processor, an object, an executable, a thread of execution, a computer program, and/or a computer. That is, a module can correspond to both a processor itself as well as a program or application running on a processor. As will be understood in the art, modules and the like can be distributed on one or more computers.

Further, references made herein to “certain embodiments,” “one embodiment,” “an exemplary embodiment,” and the like, are intended to convey that the embodiment described might be described as having certain features or structures, but not every embodiment will necessarily include those certain features or structures, etc. Moreover, these phrases are not necessarily referring to the same embodiment. Those of skill in the art will recognize that if a particular feature is described in connection with a first embodiment, it is within the knowledge of those of skill in the art to include the particular feature in a second embodiment, even if that inclusion is not specifically described herein.

Additionally, the words “example” and/or “exemplary” are used herein to mean serving as an example, instance, or illustration. No embodiment described herein as “exemplary” should be construed or interpreted to be preferential over other embodiments. Rather, using the term “exemplary” is an attempt to present concepts in a concrete fashion. In addition, the articles “a” and “an” as used in this application and the appended claims should generally be construed to mean “one or more” unless specified otherwise or clear from context to be directed to a singular form.

The following detailed description is provided, in at least some examples, using the specific context of a commercial organization that uses multiple software integration platforms, applications, services, architectures, etc., as well as modifications and/or additions that can be made to one or more frameworks and processes used in such an organization to achieve the novel and non-obvious improvements described herein. Those of skill in the art will appreciate that the embodiments herein may have advantages in many contexts other than the commercial organization situation described herein. For example, the embodiments herein are adaptable to military environments, government operations, recreation environments, retail environments, medical/health care settings, educational settings, and virtually any environment where an entity uses multiple integration platforms. Thus, in the embodiment herein, specific reference to specific activities and environments is meant to be primarily for example or illustration. Moreover, those of skill in the art will appreciate that the disclosures herein are not, of course, limited to only the types of examples given herein, but are readily adaptable to many different types of arrangements that involve monitoring integration data and costs, analyzing the monitored information, and making recommendations based on the analysis.

One challenge when organizations use multiple integration platforms to host integrations and services, including the use of distributed computing and cloud computing, is the challenge of managing and understanding an organization's costs and usage of the multiple platforms, including understanding how many platforms are being used, tracking how often they are used, and determining how to forecast future consumption of platforms, software, and/or services more effectively. For example, many organizations have specific integration needs to serve its customers. To fulfill the integration needs, business teams within a given organization may use many different integration platforms to host their integrations/services, but the organization's leadership (e.g., owners, managers, financial and operating officers, etc.) may not have good information or knowledge about the extent and/or cost of the user of the many integration platforms, especially if the platforms have been in use for long periods of time (e.g., years). For example, in a large enterprise, there may be many different message oriented middleware (MOM) platforms. As is known, MOM platforms enable application modules to be distributed over heterogeneous platforms and help to reduces the complexity of developing applications that span multiple operating systems and network protocols. However, in a given enterprise, there may be multiple applications using the MOM platforms in different ways, with several instances of them running, and this can make it difficult for each application to see how many MOM platforms it is using, what is transaction volume in these platforms, what is cost of using the platforms, are any MOM platforms being under-utilized or not even used, etc. It can be difficult for leadership to know enough about usages, capacity, and cost, to competently predict future needs and usage.

Examples of areas and concerns where organization leadership may have lack of knowledge include, but are not limited to, areas such as:
How many platforms their business is using?
How many services their business has in each platform?
Usage for a particular service type
Each service's transactions
Cost of running a transaction in each platform (cost and/or pricing model may vary by platform)
Are there any services unused?
Total monthly/annual cost
Transaction trends
Charge back model for each platform

It is advantageous for leadership of businesses to have answers and information on these areas and concerns to more effectively and optimally allocate funding for each integration platform and more accurately predict and plan for future usage of such platforms. Thus, there is a need for a framework and tool that enables users to better track operations and costs associated with distributed computing and cloud computing usage by its business units.

For example, in some large technology companies, there is no process for automatic, dynamic and regular tracking of integration platform or application usage, transactions and costs. Consequently, leaders have little to no visibility or meaningful data to help make meaningful and optimal decisions about planning for immediate needs and/or future needs. Instead, leaders have to wait for platform teams to provide reports on integration platform usage, transactions, and costs manually. Thus, capacity planning and cost forecasting can be difficult because of the lack of reports.

In some embodiments, one or more frameworks are provided to help fetch information on integration platform usage automatically, on a regular basis (e.g., daily), including information on the transactions/events that are taking place on each integration platform, costs of platform use and/or transactions/events, and other information as needed by leadership. In some embodiments, a smart asset management framework is provided that uses machine learning techniques, such as shallow learning and the Random Forest algorithm, to help improve the accuracy of predictions and forecasts about asset utilization and volumes of transactions.

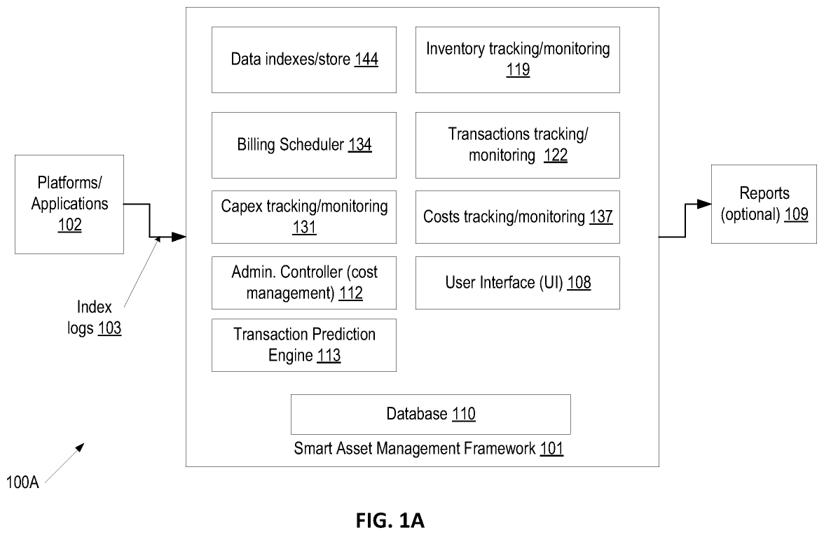

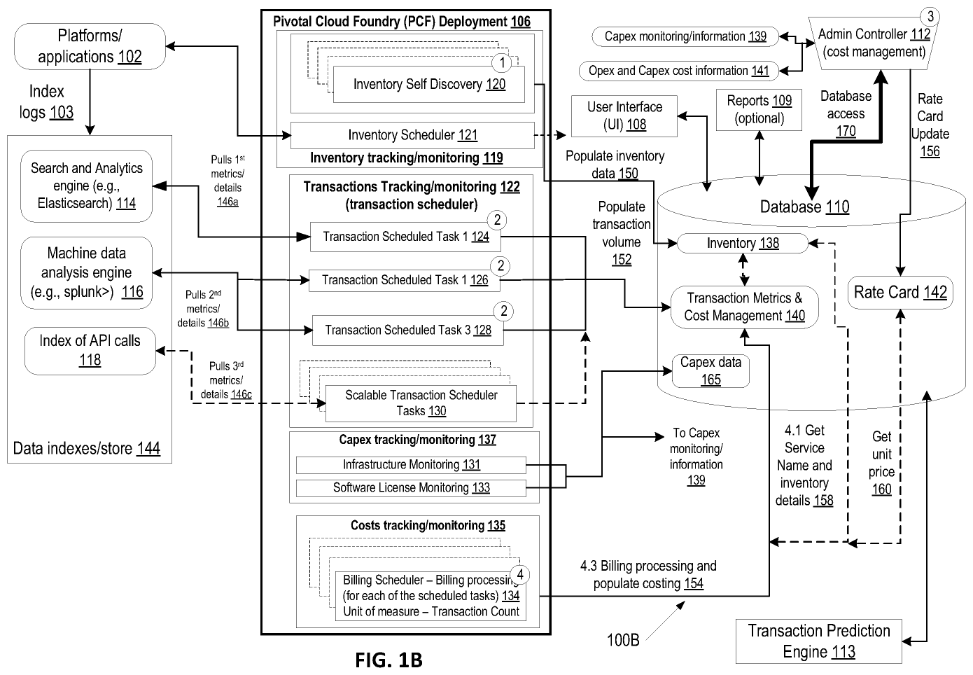

FIG. 1A is a simplified block diagram of an exemplary system 100A that is implemented in accordance with one embodiment. The exemplary system 100A of FIG. 1A shows, at a high level, the major components of a smart asset management framework 101 in accordance with at least some embodiments. The smart asset management framework 101 receives as inputs, index logs 103 and other information from one or more platforms/applications 102 (e.g., one or more integration platforms being used in a given environment, including but not limited to networked computing entities, cloud computing entities, products such as SaaS, PaaS, and/or IaaS, etc., where in at least some embodiments, an integration platform may correspond to a type of an application, may include one or more applications, or may cooperate with other integration platforms to provide and/or connect an application, etc., as defined and explained previously herein). Illustrative examples of integration platforms usable as platforms/applications, it accordance with at least some embodiments, include, but are not limited to, platforms such as business to business (B2B) platforms, service orientated architectures (SOAs), managed file transfer (MFT) platforms, as well as specific platform products such as Application Integration Cloud (AIC), which includes core components, libraries and micro services for reusability and better maintenance; AIC is an upgrade for core infrastructure and helps development of real time, batch applications and API's).

The smart asset management framework 101 provides outputs in several ways: via its user interface 108 and, optionally, via one or more types of outputted reports 109 that can be provided directly to users, e.g., via email, such as billing reports, zero transaction reports, transaction metrics, predictions of future transaction volumes, etc. In the block diagram of the exemplary system 100A of the exemplary embodiment of FIG. 1A, the smart asset management framework 101, includes a number of major components, including a set of data indexes/store 144, an inventory tracking/monitoring module 119 (which includes inventory self discovery, discussed further herein), a transactions tracking/monitoring module 122, a capital expenses (capex) tracking/monitoring module 137, a costs tracking/monitoring module 137, an Administrative Controller 112, a user interface (UI) 108, a database 110, and a transaction prediction engine. Each of these components is explained further herein.

FIG. 1B is an exemplary architecture 100B showing further details of many aspects of the Smart Asset Management Framework for the exemplary system 100A of FIG. 1A, in accordance with one embodiment. The exemplary architecture 100b is in operable communication with one or more types of computing entities (e.g., platforms/applications 102) that provide information about their operations, in the form of index logs 103, where the index logs 103 can include various types of information, including but not limited to event data associated with respective platforms/applications 102. As noted above, the applications 102, in certain embodiments, include any platform (e.g., integration platform), service, application, infrastructure, storage system, etc., that an organization or business is using, including products such as SaaS, PaaS, IaaS. Platforms/applications 102 each can create one or more respective index logs 103 (also known in the art as log indexes), or other types of logs, where the index logs can include information about any type of operation associated with a computing entity, including but not limited to anything that a platform or an application puts into its logs, such as event data, context or state information. In some instances, logs may contain information such as a record of customer activity and behavior, product and service usage, and transactions. In some instances, logs may contain records of activity for information technology (IT) components, such as applications, servers and network devices. As is understood in the art, index logs 103 provide a method of log management where logs are arranged as keys based on certain attributes, enabling the other entities like search engines, indexing engines, analysis engines, etc., to query the logs quickly to locate information of interest.

In at least some embodiments, the information in the index logs 103, as stored in the data indexes/store, constitutes historical data about transactions associated with the platforms/applications 102, and this historical data is usable not only for providing information usable for automatic creation of a complete integration inventory and transaction landscape, but is also usable for employing machine learning techniques to help predict future operations, utilization, and other aspects of the platforms/application 102, such as future volume of transactions. As is understood, knowing information such as a future volume of transactions is helpful to managers and leaders in understanding and optimizing resource usage and in providing effective planning and costing of future use resources such as integration platforms/applications 102.

The index logs 103 are sent to a set of data indexes in a data indexes/store 144. The data indexes/store 144 includes several modules that are able to search and/or retrieve relevant information from the index logs 103 provided by the one or more platforms/applications 102. These modules enable the historical information in the data indexes/store 144 to be parsed to analyze transaction information, determine when new computing entities (e.g., new platforms/applications 102) are contributing to the historical data in the index logs 103, etc. In the embodiment of FIG. 1, the data indexes/store 144 includes several components that are able to receive and/or retrieve one or more index logs 103 from one or more platforms/applications 102 and then parse or derive important and/or desired information from those logs, such as upon request from one of the engines or modules in the PCF deployment module 106, to help provide the PCF deployment module 106 with the information that its modules or engines use to help gather, parse, generate and/or populate information about the platforms/applications 102, such as usage, cost, volume, and other data. In the exemplary embodiment of FIG. 1B, the components in the data indexes/store 144 include a search and analytics engine 114, a machine data analysis engine 116, an index of application programming interface (API) calls module 118.

The search and analytics engine 114 is configured to store, search, and analyze huge volumes of data from platforms/applications 102, advantageously doing so quickly and in near real-time and give back answers about the data very quickly. For example, one usable product that can operate as the search and analytics engine 114, in certain embodiments, is the Elasticsearch product (available from Elastic, Inc. Corporation of Mountain View, California). Elasticsearch is capable of ingesting and analyzing log data in near-real-time and in a scalable manner and can provide operational insights on various log metrics to drive actions and decisions being made based on integration platform usage, transactions, and cost. Those of skill in the art will appreciate that use of Elasticsearch is illustrative and not limiting and that there are other search and analytics engines 114 available from other companies, that are also usable for this function.

Another module in the data indexes/store is a machine data analysis engine 116, such as the SaaS product Splunk, which is available from Splunk Technology of San Francisco, California. The machine data analysis engine 116 is configured to monitor, search, analyze and visualize machine-generated data from the platform/application 102, advantageously in real time. For example, the machine data analysis engine 116, in certain embodiments, is configured to capture, index, and correlate machine data in real-time in a searchable container and is able to provide various types of information about that data, such as graphs, alerts, dashboards and visualizations. Those of skill in the art will appreciate that use of Splunk is illustrative and not limiting and that there are other machine data analysis engines 116 available from other companies, that are also usable for this function.

The index of API calls 118, in certain embodiments, may include information on API calls/events, which may be created/logged whenever an API operation is invoked. As is known, an API call allows one application (e.g., a web application) to request data or services from another application. The index of API calls 118, in certain embodiments, stores this information so that metrics, details, and other pertinent information, can be provided to the PCF deployment module 106, as discussed below.

The set of data indexes/store 144 communicates components of the pivotal cloud foundry (PCF) deployment module 106, providing to the PCF deployment module 106 (and its components, e.g., the modules/engines discussed herein) various types of information (e.g., metrics/details 146a-146c) that are used to help deploy functionality that enables the Smart Asset Management Framework 101 to fetch inventory information and transactions information from each platform at desired intervals (e.g., daily). The set of data indexes/store 144 also provides a way for historical integration platform/application 102 information and data to be stored in database 110. In some embodiments, the components of the PCF deployment module 106 are configured to request or pull metrics/details 146a-146c, as needed, from one or more components of the data indexes/store 144, as shown in FIG. 1B. For example, as shown in FIG. 1B, the transactions tracking/monitoring module 122 includes several tasks that are configured to retrieve various metrics/details from the data indexes/store 144. The transaction scheduled task 1 114 pulls a set of first metrics/details 146a from the Search and Analytics engine 114. The transaction scheduled task 2 116 pulls a second set of second metrics/details 146b from the machine data analysis engine 115, as does the transaction scheduled task 3 118. Each transaction scheduled task (TST) is a task that needs to be scheduled by a scheduler. A scalable transaction scheduler tasks module pulls a set of third metrics/details 146c from the index of API calls 118. Note that a scalable transaction scheduler (STS) is a scheduler that schedules different tasks to be run at a specific time. STS can be scaled up or down by increasing or decreasing the tasks to be scheduled. This is discussed further herein.

The inventory tracking/monitoring module 119 includes an inventory self discovery module 120 that cooperates with an inventory scheduler 121 to acquire integration inventory information from all platforms/applications 102, including when new platforms/applications 102 are added to an organization. That is, the inventory self discovery module can discover, based on the historical data (information in index logs 103), when new platforms/applications 102 are contributing to the index logs 103. The inventory scheduler 121 obtains an initial data load from each platform/application 102 and is configured to collect all the inventory details about the platform/application. The inventory details, in certain embodiments, include, but are not limited to, information relating to characteristics of the integration platforms, such as how many virtual machines are running or available, what applications are running on entities and/or devices on the platform, the types of operating systems (OS) that are running, how many central processing units (CPUs) are running, the size of storage or memory, etc. The inventory scheduler 121 helps to keep track of incremental data associated with the inventory of platforms/applications 102 used in an organization, such as data indicating if new message providers are installed or new messaging has been deployed.

For example, in certain embodiments, the inventory scheduler is configured to fetch or retrieve inventory details from each of the platforms/applications 102, via the index logs 103 that the platforms/applications 102 provide to the data indexes/store 144, where the PCF deployment module 106 stores that information in the database 110 to help ensure that the that database inventory data always is in sync with platform data. As will be appreciated, in certain embodiments, for each platform/application 102, an inventory unit will be different. For example, the inventory units with a first platform/application 102 might be size of memory, for a second platform/application 102 it might be types of OS, etc.

In certain embodiments, the inventory scheduler 121 is run at predetermined periodic or predetermined time intervals, such as a Java process that is run once a day, but this is not limiting. The inventory scheduler 121 also could be run at periodic intervals based some factor other than time, as will be appreciated, such as based on the existence of a condition, receiving information that a new computing entity is being added or delete, when a certain cost threshold is reached, etc. As will be understood, the frequency with which the inventory scheduler 121 (and other schedulers and periodic processes described herein) is run depends on the implementation requirements and performance tradeoffs in an organization, such as how frequently the organization wants data to be in sync versus impact on platform/application 102 performance and other performance considerations. In certain embodiments, the inventory self discovery module 120 also can receive inventory details automatically, effectively in near real-time, by parsing and analyzing information provided via the modules in the data indexes/store 144, such as from the metrics/details 146a-146c provided by the search and analytics engine 114, the machine data analysis engine 115, and/or the index of API calls 118, to help keep the inventory data 150 up to date. The inventory self discovery module 120 and the inventory scheduler 121 cooperate to provide inventory data 150, so that the inventory data 150 can be used to populate the inventory information 138 stored in database 110.

The PCF deployment module 106 also includes a transactions tracking/monitoring module 122 (also known herein as transactions scheduler 122) which cooperates with the transaction scheduled tasks 124, 126, 128 and the scalable transaction scheduler tasks 130, to provide information on transactions (e.g., transaction volumes 152) to the database 110. In certain embodiments, one or more of the platforms/applications 102 may be generating transactions, such as generating messages corresponding to data flow between multiple platforms/applications 102. In certain embodiments, after inventory data is collected (e.g. via the aforementioned inventory self discovery module 120 and after the inventory scheduler 121 has run), the PCF deployment module 106 collects information on each integration platform's transactions.

For example, the transactions tracking/monitoring module 122 is configured to fetch transaction details from the platforms/applications 102 (via the information in the data indexes/store 144) and store that transaction detail information (e.g., the transaction volume information 152) in the database 110. As will be appreciated, transaction details and the payload of information that is fetched may vary depending on the platform/application 102 and the details may include, but are not limited to, information such as transaction identifier (id), source application, target application, payload, timestamp, etc. In at least some embodiments, the transaction units are different for each platform/application (similar to inventory discovery). In certain embodiments, the transactions tracking/monitoring module 122 is configured to tailor the transaction information that is fetched (e.g., from the data indexes/store 144) based on the platform/application and the information that is of interest to organization leadership, or information that is needed to implement other features, such as cost estimates and prediction of future needs 102. In certain embodiments, the transactions tracking/monitoring module 122 performs this tracking via a periodic (e.g., once a day) process (e.g., a Java process) that runs to fetch transaction details from a previous time period. In certain embodiments, the transaction scheduler process run by the transactions tracking/monitoring module 122 is configured to run after the inventory scheduler 121.

FIG. 1B illustrates several exemplary tasks that the transaction scheduler process of the transactions tracking/monitoring module 122 runs. The transaction scheduled task 1 114 pulls first metrics/details 146a from the search and analytics engine 114. The transaction scheduled task 2 116 and transaction scheduled task 3 118 each pulls second metrics/details 146b from the machine data analysis engine 116. The scalable transaction scheduler tasks 130 pulls set of third metrics/details 146c from the index of API calls 118. The machine data analysis engine 116 and/or the search and analytics engine 115 can have more than one “pull” from the transaction scheduled tasks. In certain embodiments, the first, second, and third transaction scheduled tasks 124, 126, 128 are automated processes, and no manual effort is needed to collect either inventory or transaction information. The information that these transaction scheduled tasks 124, 126, 128 retrieves are provided to populate transaction volume 152 information in the database 110. For example, the database 110 includes the section named transaction metrics and cost management section 140, which section is configured with multiple tables to store the transaction details. In at least some instances the transaction details are different for each platform/application 102, and the database 110 is configured to create, automatically, the appropriate tables with fields appropriate for the transaction details.

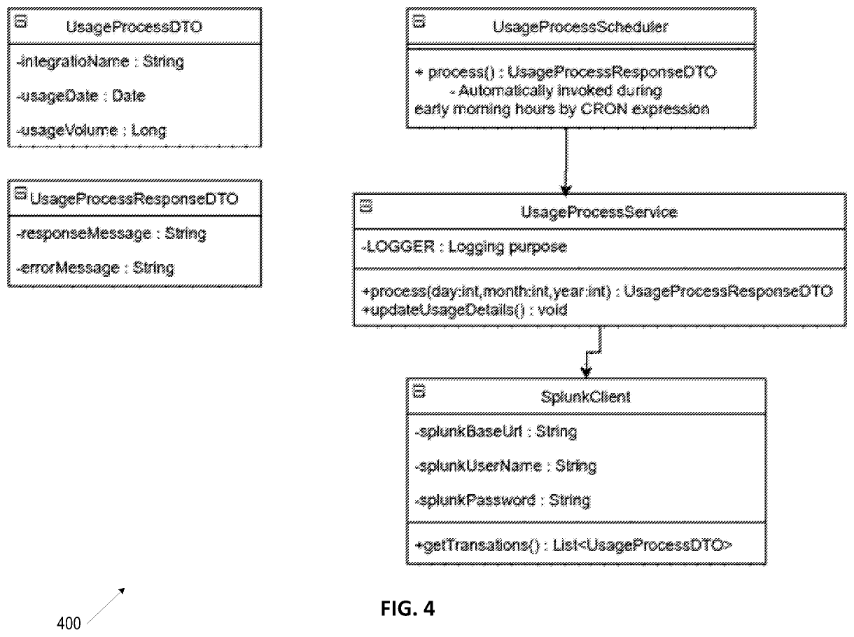

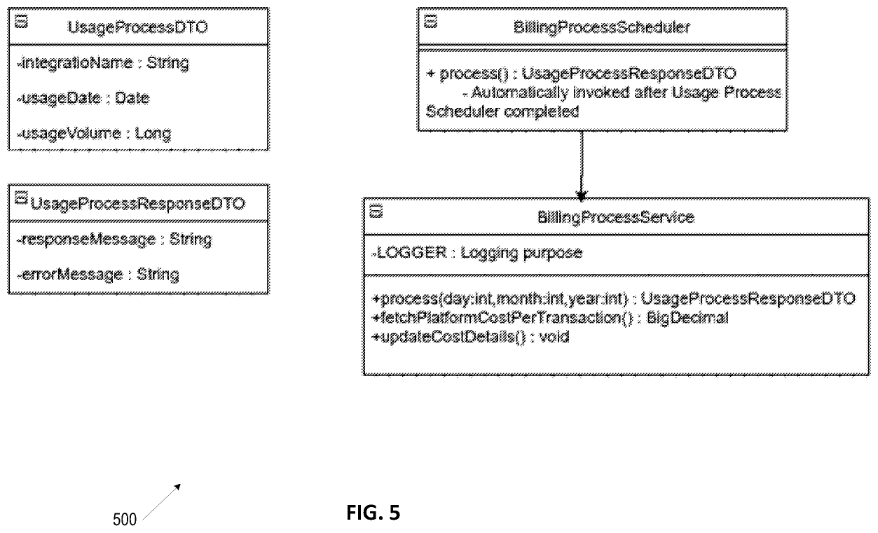

Referring briefly to FIG. 4, FIG. 4 is an exemplary transaction scheduler class diagram 400 for the transactions tracking/monitoring module 122 (also known as transaction scheduler 122) used in the exemplary system of FIG. 1A and the exemplary framework architecture of FIG. 1B, in accordance with one embodiment, where the transaction scheduler runs as part of the transactions tracking/monitoring module 122, as discussed above. The transaction scheduler, in certain embodiments, is configured to fetch transaction details from the platforms/applications 102 and store the information in the database 110. The exemplary class diagram 500 shows that the transaction scheduler of this example embodiment is configured to be run automatically during early morning hours. In the exemplary class diagram 500, it is shown as being configured for retrieving transaction information from a Splunk client (e.g., for an embodiment where Splunk is used for the machine data analysis engine 116). As those of skill in the art will appreciate, the exemplary class diagram 500 is illustrative and not limiting.

Referring again to FIG. 1B, the capex tracking/monitoring module 137 of the PCF deployment module 106 includes two components that perform further processes to gather information about resource usage. The infrastructure monitoring module 131 is configured, in certain embodiments, as a process (e.g., a Java process) that runs periodically (e.g., daily). Advantageously, the process of the infrastructure monitoring module 131 is run at a time when it is less likely to interfere with user and system activities, such as during the early morning hours. The infrastructure monitoring module 131 is configured to get information about characteristics relating to utilization of each server or other computing entity, that it is configured to monitor as part of the smart asset management system 101. For example, in certain embodiments, the infrastructure monitoring module 131 gets information on central processor unit (CPU) utilization, memory utilization, and/or storage utilization of each server that an organization is using. The infrastructure information is stored in the database 110 (e.g., in capex data 165) so that the information is usable to generate reports by platform, by server, by instance, etc. Analysis of the reports can help an organization efficiently and/or cost-effectively make use of servers, such as by reducing some servers having underutilized capacity.

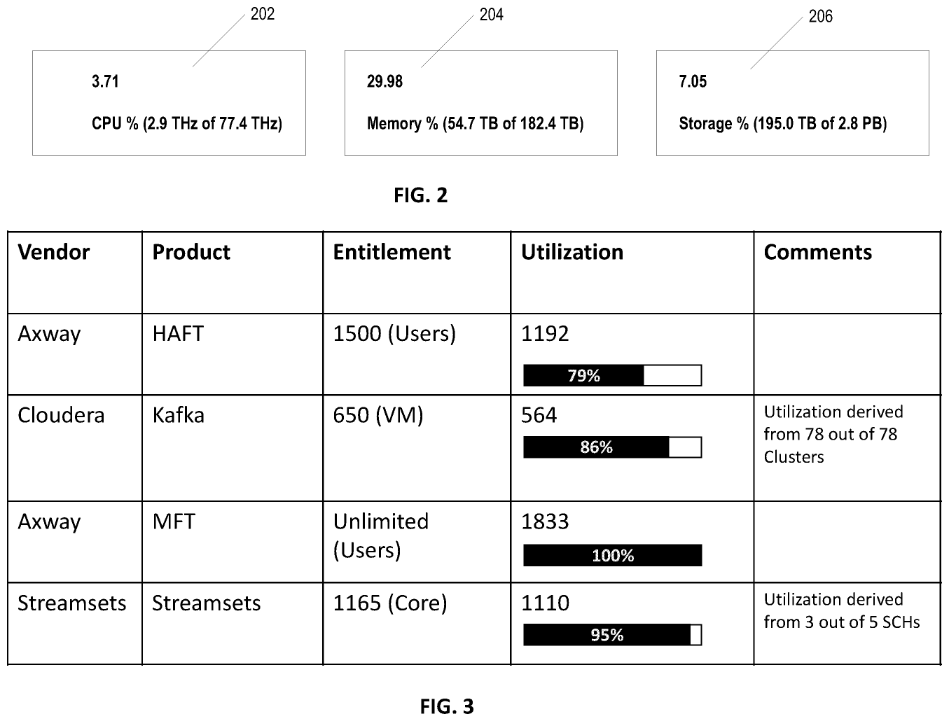

Referring briefly to FIG. 2, FIG. 2 is an exemplary graphic showing exemplary infrastructure monitoring information determined using the exemplary system 100A of FIG. 1A and exemplary architecture 100B of FIG. 1B, in accordance with one embodiment. For example, block 202 shows that a first server has 3.71% CPU utilization, block 204 shows that the first server has 29.98% memory utilization, and block 206 shows that the first server has 7.05% storage utilization.

Referring again to FIG. 1, the capex tracking/monitoring module 137 also includes a software licensing module 133. In certain embodiments, the software licensing module 133 is configured to run a process that interacts with each platform/application 102 and retrieves the license usage details for that platform/application 102. It will be appreciated that in some embodiments, for each platform, the license “unit” will be different. An application/platform team in an organization will have knowledge of the total licenses (if any) that they have purchased. Based on the license usage details and knowledge of total licenses, the exemplary architecture 100b is able to generate reports for all platforms/applications 102 in one view.

Referring briefly to FIG. 3, FIG. 3 is an exemplary table showing software license monitoring determined using the exemplary system of FIG. 1A and the exemplary architecture of FIG. 1B, in accordance with one embodiment. As FIG. 3 illustrates, four different licensed platforms are shown and the respective number of entitlements (rights to use and/or access software) and percent utilization of the respective license is also shown. The percent utilization in this example table shows that three of the platforms are at less than 100% utilization and one platform (Axway MFT) is at 100% utilization (this no percent is shown in the graphic, since the bar depicting usage is completely filled in.

Referring again to FIG. 1B, the PCF deployment module 106 also includes a costs tracking/monitoring module 135 that is configured to receive and/or retrieve information on the transaction details and the unit price of each transaction and then can generate the billing process and populate total cost, e.g., using a billing scheduler 134 (discussed further below). The costs tracking/monitoring module 135 provides information such as billing processing and other costing, to populate a designated transaction metrics and cost management section 140 in database 110. The transaction metrics and costs management section 140, in certain embodiments, includes data such as transaction details (e.g., transaction metrics), unit price per transaction, and total cost. Using at least this information, the exemplary architecture 100b is configured to build a transaction cost metrics dashboard that can display information associated with these details, in a dashboard presented on the UI 108, as part of one or more reports 109, or in any other desired way. For example, in certain embodiments, cost management information may be displayed according to leaders or application.

In certain embodiments, the billing scheduler 134 is a process that is configured to run periodically (e.g., daily). In certain embodiments, the billing scheduler 134 is configured to run in coordination with other schedulers being run on the PCF deployment module 106, such as being run after the inventory scheduler 111 and transaction scheduler 122 (transactions tracking/monitoring 122). The billing scheduler 134 is configured to calculate all transaction costs per desired period (e.g., per day). In addition, as shown in FIG. 1B, information from the billing scheduler 134 is also provided to a rate card section 142 in the database 110 (rate card section 142 is discussed further herein).

Reference is now made briefly to FIG. 5, which is an exemplary class diagram 500 for the billing scheduler 134 used in exemplary system of FIG. 1A and the exemplary framework architecture of FIG. 1B, in accordance with one embodiment. The billing scheduler 134 is configured to calculate the cost of each entity in inventory and all the transaction costs per desired time period (e.g., by day) for a given platform/application 102 and then update the information in the database 110. As will be appreciated, the billing scheduler class diagram 500 is exemplary and not limiting.

Referring again to FIG. 1B, the administrative controller 112 is a module that is in operable communication with the database 110 in several ways, as well as being in operable communication with the output of capex tracking/monitoring module 137 and in operable communication with a source of operating expense (opex) and capex cost information 141. The administrative controller 112 communicates with the rate card section 142 of the database 110 and generally has database access 170 to all parts of the database 110 that are necessary for it to perform its functions. For example, the administrative controller 112 is a module that helps in computing a cost of each transaction, which is part of the rate card section 142, so the administrative controller 112 has access to costing information and other appropriate information in the database (e.g., as stored in the transaction metrics and cost management section 140) relating to the transactions.

In at least some organizations, the capex and opex cost information 141 is not the type of information that changes within shorter periods of time (e.g., daily), in comparison to transaction information, which by its nature is likely to vary each day, as will be understood. For example, a platform/application 102 team at an organization has access to total annual opex expenses and opex cost information 141, and the platform/application team can make the opex and cost information accessible or available to the administrative controller 112. The administrative controller 112 makes use of the capex and opex cost information 141, along with the information from the capex tracking/monitoring module (capex monitoring/information 139) to help provide information for the updated rate card information 156.

By knowing the total annual opex costs, annual capex costs, infrastructure utilization, software licensing costs and arrangements, transaction details and types, and numbers of transactions of that platform, the administrative controller 112, in certain embodiments, is configured to create, automatically, a complete integration inventory and transaction landscape configured to provide information and reports to help leadership optimize business planning and decision-making. In certain embodiments, the administrative controller 112 is configured to make recommendations for optimizing use of the platforms/application, including, in some embodiments, recommendations based on predictions from the transaction prediction engine 113. For example, in some embodiments, the administrative controller 112 makes recommendations automatically, based on information in the landscape, to alert users/managers that one or more aspects of system operation, utilization, allocation, etc., should be changed or modified to save money, improve efficiency, and/or optimize operations. The complete integration inventory and transaction landscape information can be stored in database 110 and made available to the UI 108 and/or in reports 109.

The administrative controller 112 can then calculate the cost of each transaction using an averaging technique, and this information can be part of the rate card section 142 stored in the database. For example, in one embodiment, the averaging technique uses total opex and capex by platform/application 102, over the total volume that each platform/application 102 supports. Based on these numbers, a cost per transaction can be determined. For example, if a given platform/application 102 has a monthly charge, that charge can be divided by the number of transactions tracked over a month, to get an approximate estimate of a per-transaction charge for that application. In certain embodiments, the cost per transaction is a “one time” activity, and the cost per transaction does not change frequently.

The rate card section 142 of the database gets information from the transaction metrics and cost management section 140, such as information from the section labeled as inventory information 138, service name and inventory details 158, and unit price information 160, as well as updated rate card information 156 from the administrative controller. The rate card section 142 provides information (e.g., a lookup table) of a cost per unit of computing resources, such as platforms/applications 102, storage, CPU, RAM, network resources, IP addresses, email addresses, enterprise backup, input/output operations per second (IOPS), websites, etc., where the unit can be based on time, quantity, or any other desired measurement.

In addition, in certain embodiments, data stored in the database 110 is used for billing and for providing information for reports 109, if desired (e.g., emailed reports, posted reports, etc.). In certain embodiments, based on information stored in the database, the administrative controller 112 helps to generates a “zero transactions report,” which is a report configured to identify platforms/applications 102 that do not have any active transactions for a given or predetermined time period. The zero transactions report can help to provide insight into opportunities of capacity buy back.

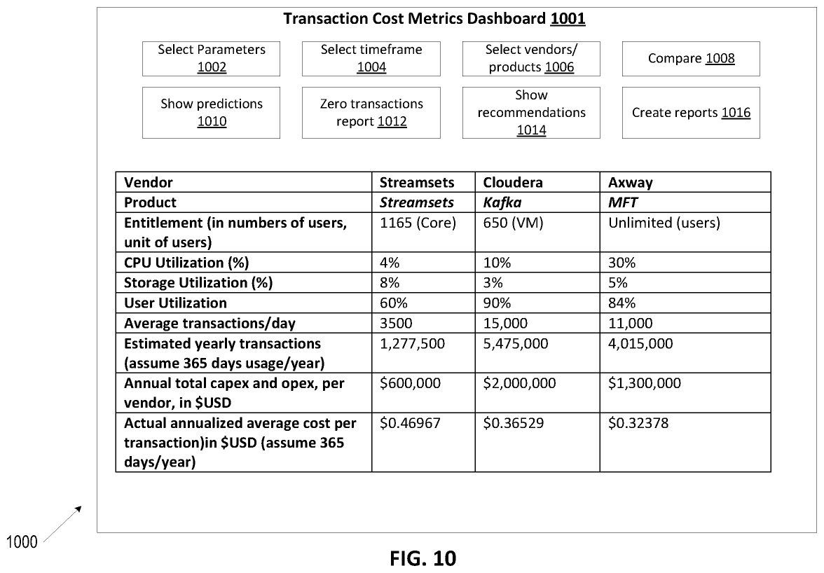

In various embodiments, the UI 108 and/or reports 109 can provide many different kinds of reports, including but not limited to reports such as inventory metrics, transaction metrics, transaction cost metrics, infrastructure utilization metrics etc. These and other types of reports enable an organization using the smart asset management framework 101 to have data driven, insightful and value-based conversations with it internal teams, partners, customers, and vendors. Advantageously, in certain embodiments, by providing easy-to-read dashboards (e.g., as shown and discussed herein in connection with FIG. 10), users and/or owners of platforms/application 102 are able to see and/or visualize the traffic that different platforms/applications 102 are producing. by displaying transaction data. This benefits not only the owners and users of platforms/applications 102, but also leadership and management. Leaders and management are able to see their overall platform/application 102 consumption and the total cost it takes to run their platforms/applications, which enables them to optimize and advantageously lower the cost of operations. These reports also enable greater visibility into seeing how platforms/applications 102 are adopted and/or being used across different segments of their business, what additional automations to be delivered, etc. In some embodiments, reports such a zero transactions report can be provided, to help identify platforms/applications 102 that do not have any active transactions for a predetermined time period, which can provide insights to opportunities of capacity buy back.

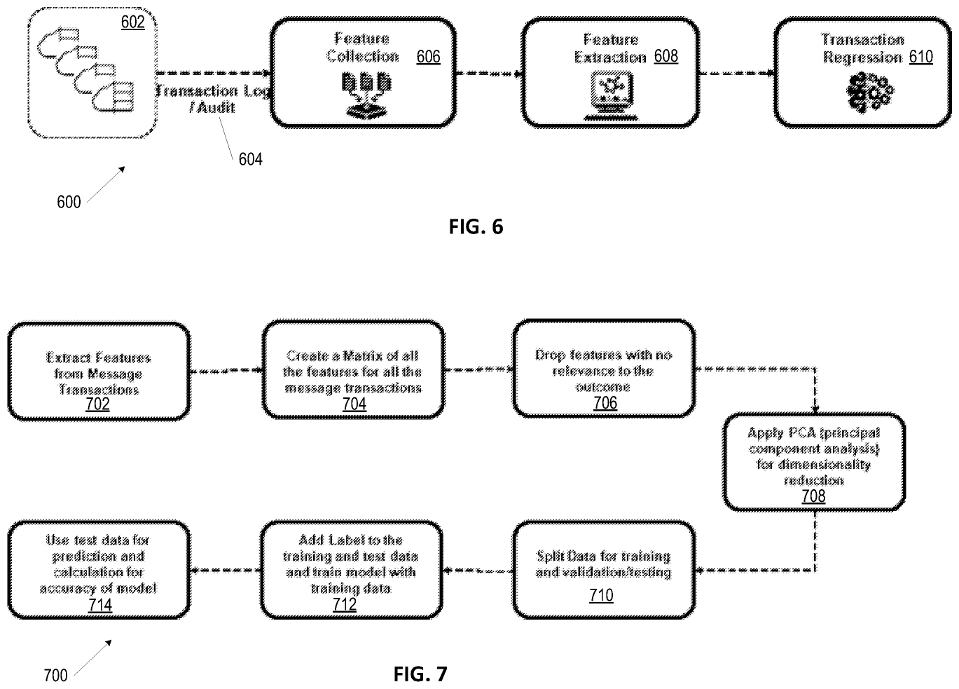

As can be seen in the above descriptions of the components of the exemplary architecture 100b, the database 110 stores information on all the inventory, transactions and cost data. This information is used by both the transaction prediction engine 113 (discussed further herein in connection with FIGS. 6-12) and the administrative controller 112. The administrative controller 112 uses database information to generate a dashboard of information to provide on the US 108, such as a “‘Transaction Cost Metrics’ Dashboard,” where information can be displayed on the UI 108 based on desired filters, such as according to leaders (such as leadership team, management, etc.), platforms/applications, etc. The transaction prediction engine 113 uses information in database 110 to help predict future utilization and costs, such as future transaction volumes, in connection with machine learning techniques, as described further herein.

FIG. 10 is an exemplary representation of a user interface 1000 of an exemplary transaction cost metrics dashboard 1001, in accordance with the exemplary system of FIG. 1A and the exemplary architecture of FIG. 1B, in accordance with one embodiment. This exemplary transaction cost metrics dashboard 1001 provides user options to select what appears in the UI 108, including but not limited to examples of options that a user can select to tailor the information displayed on the dashboard, such as:
select parameters 1002 option (e.g., to show the details and characteristics in the table 1000, such as “user utilization” and/or “annual total capex and opex, per vendor” as will be understood);
select timeframe 1004 (e.g., to determine how many days/weeks/months/years of data to use);
select vendors/products 1006 (e.g., as shown in the table, to select the vendors and/or products whose utilization and costs are analyzed/compared);
compare 1008 (to show a comparison, e.g., of selected platforms, based on selected parameters);
show predictions 1010 (this is not depicted in this exemplary dashboard, but is discussed further herein);
show recommendations 1012 (this is not depicted in this exemplary dashboard, but is discussed further herein);
create reports 1016 (this refers to reports 109, which are external to the dashboard but may be emailed, printed, posted, etc., as will be appreciated).

As will be appreciated by those of skill in the art, the user interface of FIG. 10 is exemplary and not limiting, and many different embodiments of a user interface are possible.

In addition to monitoring and tracking transactions, utilizations, and costs, it can be important to predict future needs and utilizations in these areas, especially being able to predict important factors such as transaction volumes, which can be an important factor in determining expenses of complex integration platforms and applications. This, the exemplary architectures 100B of FIG. 1B also includes the transaction prediction engine 113, which is now described.

In a configuration where a new integration platform or new application is being implemented and used, where there is not yet data (e.g., historical data) on transaction volumes, it can be very difficult to predict future transaction volumes. However, in certain embodiments herein, it is possible to utilize historical transaction data of these types of integration platforms and applications, and also look at current data, to help to try and predict future users and/or uses of resources. For example, if it is a first deployment of an integration platform/application 102 into a production environment, the historical data that can be used can include (but is not limited to), user acceptance tests (UAT) that may be very close to a production environment. As is understood, subsequent production deployments can have more historical data that is based at least in part on previous deployments. In certain embodiments, by using training of the system of FIG. 1A and the architecture of FIG. 1B, a sophisticated machine learning model (e.g., a machine learning based regressor) can predict the volume of transactions (as well as other information) in the future with high degree of accuracy. The transaction prediction engine 113, in certain embodiments, implements the machine learning based regressor.

As historical transactional data of each integration platform/application 102 are logged into an enterprise logging systems (e.g., by sending the index logs 103 to the data indexes/store 144, as discussed previously in connection with FIG. 2B), such as by providing data to machine data analysis engine 116 like Splunk, and/or to a search and analytics engine 114 such as Elasticsearch (and its ELK stack), data can be harvested from the data stored in these engines and built into a training dataset and a validation/testing dataset, as discussed further below. This index log information stored in these engines, in certain embodiments, includes multi-dimensional data that includes features like integration pattern (synchronous, asynchronous, request/reply, pub/sub), platform/application types(AIC, B2B, SOA etc.) as well as additional information such as publishers and subscriber numbers. This multi-dimensional data can be analyzed, after feature engineering is applied to PCA (principal component analysis) for dimensionality reduction. Once the data is ready, it can be split for training and testing for the model. Data also can be harvested from database 110.

For example, FIG. 6 is a first high level exemplary flow diagram 600 of a transaction prediction process of the exemplary system of FIG. 1A and the exemplary architecture of FIG. 1B, in accordance with one embodiment, which may be implemented as part of the transaction prediction engine 113. Block 602 corresponds to the data stored in database 110 and/or in the data indexes/store 144. This data is accessed via a transaction/log audit 604 and provided to a feature collection module 606, which then provides an output to a feature extraction module 608, which then provides an output to a transaction regression module 610.

FIG. 7 is a second exemplary flow diagram 700 of a transaction prediction process of the exemplary system of FIG. 1A and the exemplary architecture of FIG. 1B, showing further details of the process actions of FIG. 6, in accordance with one embodiment. The second exemplary flow diagram 700 illustrates the details of steps for analyzing transaction data to help generate information to train a machine learning regressor model to help predict future transaction volumes. In certain embodiments, a procedure known in the art as “train-test-split” is used as part of the process. As is known in the art, the train-test split procedure is used to estimate the performance of machine learning algorithms when they are used to make predictions on data not used to train the model, where train-test-split can be advantageous on larger sets of data.

Referring to FIG. 7, in block 702, features are extracted from message transactions, where the features, as noted previously, may include, but are not limited to, integration pattern, platform type, publisher, subscriber number, etc. In block 704, a matrix is crated of all the features for all the message transactions. Forming a matrix is advantageous because it facilitates feature reduction, dimensionality reduction, and splitting. In block 706, features are dropped/reduced from the matrix if the features have no relevance to the outcome. For example, features (e.g., serial number) that have no correlation to the dependent variable in the analysis (e.g., if the dependent variable in the analysis is transaction volumes or is related to transaction volumes) may be viewed as extraneous and not correlated to transaction volumes. Features that have no correlation can include things like a product number, government compliance information, product details (e.g., for an order), etc., as will be understood in the art. These features are irrelevant to the problem of predicting a future volume of transactions and may be removed or eliminated from the collected information and not included in features used to develop training and test data. However, features that are more important or highly correlated with the dependent variable (i.e., transaction volume) will be retained. In some embodiments, predictive modeling algorithms (such as Random Forest) may be trained and used to determine the most relevant features. In some embodiments, feature extraction can be performed to extract new features from the historical information.

In block 708, principal component analysis (PCA) is applied for dimensionality reduction of the matrix, as is understood in the art. In block 710, the data resulting after the PCA is split for training and validation/testing (e.g., to validate the machine learning regressor model). This can be done in various ways as is known in the art. For example, a certain percent (e.g., 70%) of the rows in the matrix of data be randomly sampled and then allocated into a set of training data, and the remaining data (30%) can be allocated into a set of testing data, but these percentages can be varied and are not limiting, as is known in the art. Referring still to FIG. 7, in block 812, labels are added to the training and test data and the models are trained with the training data. In block 814, the test data is used for prediction and calculation for accuracy of the machine learning regressor model (i.e., to validate the machine learning regressor module).

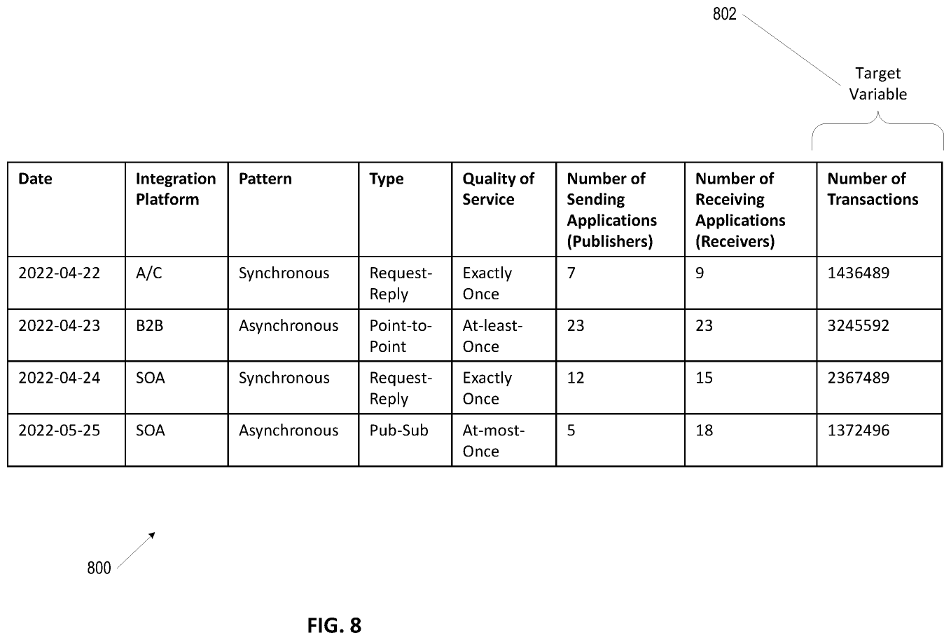

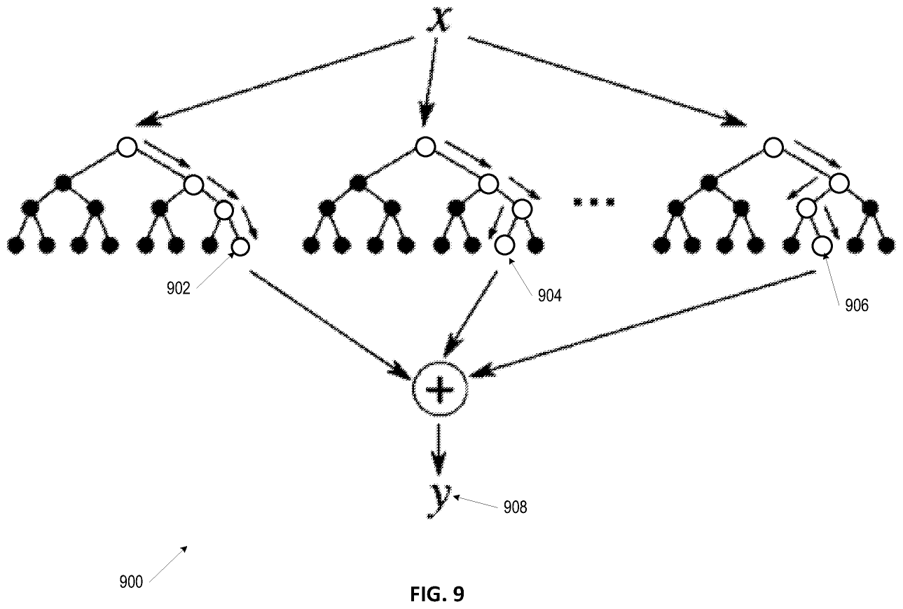

For example, FIG. 8 is an exemplary table 800 of sample data used to train a regression model for prediction, derived in accordance with the method of FIG. 7 and usable with the exemplary system of FIG. 1A and the exemplary architecture of FIG. 1B, in accordance with one embodiment. Note that the sample of data shown in FIG. 8 is for demonstration purposes and does not contain all features necessary to train the regressor for predicting the future volume of the transaction. FIG. 8 shows that a certain column of data, the target variable 802, is labeled as the “target” variable. This means that this variable (number of transactions) is the so-called “y” variable that is being predicted in the machine learning algorithm, and the other columns correspond to the so-called “x” data set of features used to test the machine learning algorithm.

In certain embodiments, shallow learning approaches are leveraged to build the regression model for prediction. It's possible to apply deep learning in this case but considering the use case discussed herein, shallow learning would is a more optimal choice. A shallow learning approach is appropriate when there is less data dimensions and a less efforts are expected for training the model. In at least some embodiments, a Random Forest algorithm is chosen for prediction and recommendation because of its efficiency and accuracy of processing huge volume of data. This reduces the variance and the bias stem from using a single classifier. The final regression is achieved by aggregating the predictions that were made by the different regressors. As a shallow learning option, an ensemble bagging technique with a Random Forest algorithm is utilized as a regressor approach for predicting the future volume of the transactions. As is known, ensemble learning is a machine learning technique in which multiple individual models, sometimes referred to as base models, are combined to produce an effective optimal prediction model. ensemble methods refer to a group of models working together to solve a common problem. Rather than depending on a single model for the best solution, ensemble learning utilizes the advantages of several different methods to counteract each model's individual weaknesses. The resulting collection theoretically will be less error-prone than any model alone. The Random Forest algorithm is an example of ensemble learning.

As is also known in the art, Random Forest is a machine learning technique used to solve regression and classification problems. Random Forest makes use of ensemble learning (which combines many classifiers to help solve complex problems). An exemplary implementation of a Random Forest algorithm includes multiple decision trees that form a “forest”. The Random Forest algorithm is trained via bagging (bootstrap aggregating), including using multiple regressors (this can be done in parallel) each trained on different data samples, and different features. As is known in the art, bagging implements an aggregation of multiple versions of a predicted model, where each model is trained individually, and then the models are combined using an averaging process. Bagging helps to achieve less variance than any model has individually. In addition, Random Forest generates an outcome based on the predictions of the decision trees, where a prediction is made by taking the average or mean of the output from various trees. As will be understood, increasing the number of trees in the forest helps to increase the precision of the outcome.

FIG. 9 is an exemplary diagram of a Random Forest regressor structure 900 used with embodiments of the exemplary system of FIG. 1A and the exemplary architecture of FIG. 1, in accordance with one embodiment. As FIG. 9 illustrates, the Random Forest is composed of multiple decision trees, and each decision tree is constructed using different features and different data samples which reduces the bias and variance. In the training process the trees are constructed using the training data that was derived in FIGS. 6-8. In the testing process, each new prediction that needs to be made runs through the different decision trees, where each decision tree yields a score and the final prediction is determined by the average of all predictions. Each decision tree may include some “weak” learnings, but because lots of decision trees are used in the algorithm, all of the “weak” learners can be combined to create a strong model.

In FIG. 9, the black and white circles represent “leaves” in a decision tree, and the white circles represent “leaves” that show a certain pattern of decisions that lead to three possible end results: first result 902, second result 904, and third result 906, where each of the first, second, and third results, can then be averaged to create final prediction 908. For example, if the X input in FIG. 8 corresponds to the presence of a particular feature (e.g., a feature shown in FIG. 9 set, such as high number of sending applications) or set of features, in any data relating to transaction volumes, the decision trees may correspond to that feature in combination with certain other features in the example of predicting a future transaction volume. As FIG. 9 shows, these three results are averaged to lead to a final prediction 908.

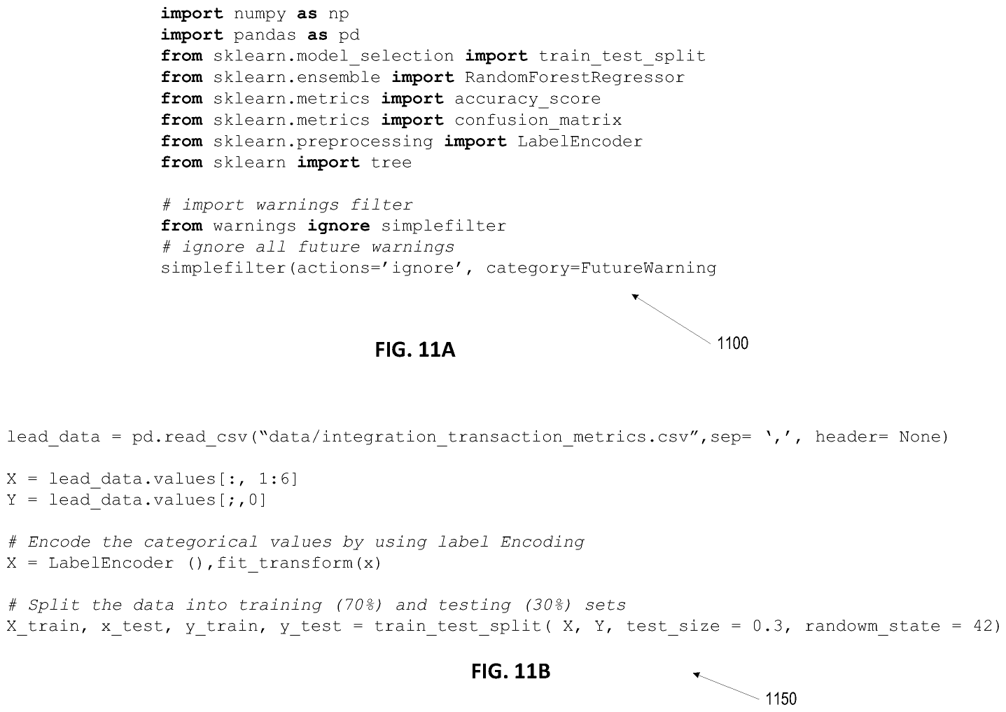

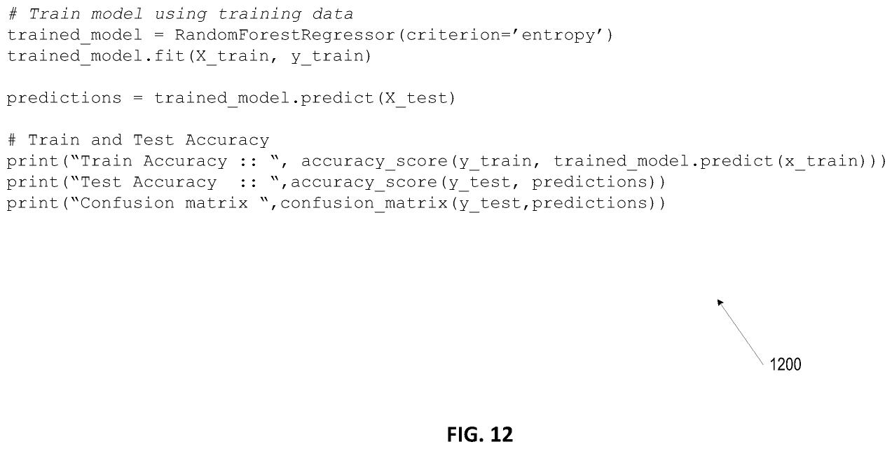

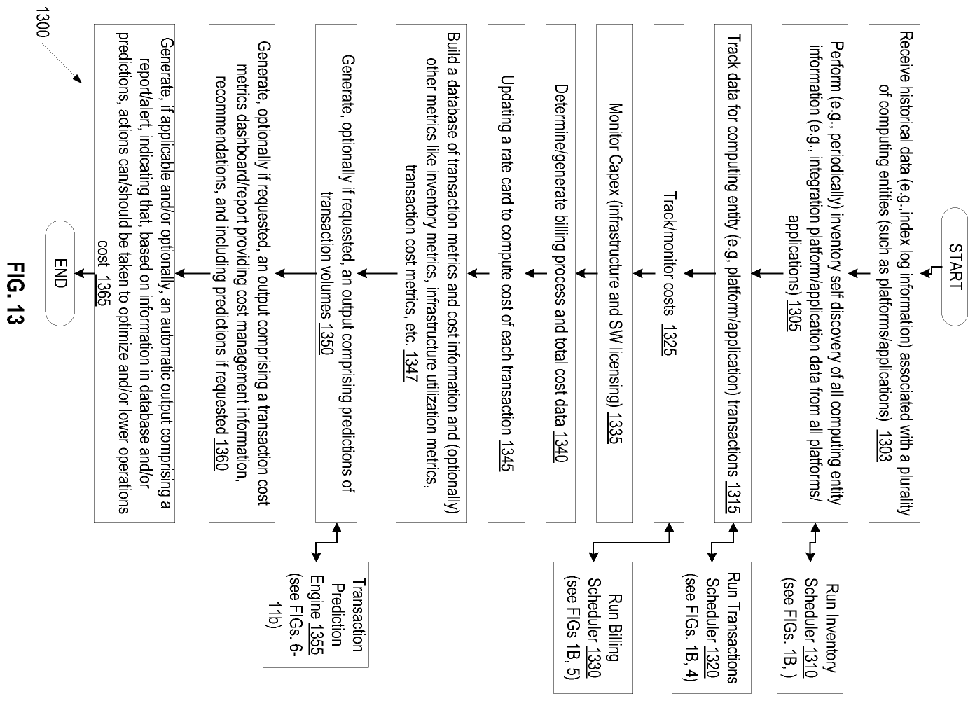

As will be appreciated, the transaction prediction engine 113 can be implemented in many different ways. In one embodiment, a transaction prediction engine 113 is implemented and built using SciKitLearn libraries (available from the scikit-learn organization) with Python programming language. The sample code for a proof of concept (POC) to achieve regression using Random Forest to predict the volume of transaction is shown in FIGS. 11A-12, discussed further below. First the necessary libraries like ScikitLearn, Pandas (an open source Python package) and NumPy (fundamental package for scientific computing in Python) as well as other necessary libraries, etc. are imported by using the following code as shown in the snippet of FIG. 11A, which is an exemplary listing 1100 of sample code to achieve regression using Random Forest to predict the volume of transactions for the exemplary system of FIG. 1A and the exemplary architecture of FIG. 1B, in accordance with one embodiment.

The next implementation step is to read the integration transaction data file to create the training dataframe. In one embodiment, the data is created as a comma separated value (CSV) file and the data is read to a Pandas data frame. The data is separated into the independent variables or features (X) and dependent variable or target value(Y) based on the position of the column in the dataframe. The categorical data in the features are encoded by passing to LabelEncoder. As the target variable in this case contains the total number of transactions which is an integer, no need to encode that value. Then the data is split into training and testing sets using train_test_split function of sklearn library. In an example embodiment, the training set contains 70% of the observations (i.e. logged data) while the testing set contains 30%, but this is not limiting. Exemplary code for this is shown in FIG. 111B, which is an exemplary listing 1150 of sample code usable to split integration transaction data into training and testing sets, for the exemplary system of FIG. 1A and the exemplary architecture of FIG. 1B, in accordance with one embodiment.

After splitting the data, a Random Forest Regressor is created using sklearn library with the criterion hyperparameter as “entropy”. The model is trained using the training data sets, both independent variables (X train) and target variable (y train). Once trained, the model is asked to predict by passing the test data of independent variable (X test). The predictions, accuracy and confusion matrix are then printed. For example, in certain embodiments, the predictions, accuracy, and confusion matrix are printed, where the printing prints the output part of the code, to help the implementor with output information. Exemplary code for doing this is shown in FIG. 12, which is an example listing 1200 of sample code usable for training a model using training data sets and testing accuracy of the model, for the exemplary system of FIG. 1A and the exemplary architecture of FIG. 1B, in accordance with one embodiment.

FIG. 13 is a simplified flowchart showing high level operations of the exemplary system of FIG. 1A and exemplary framework architecture of FIG. 1B, in accordance with one embodiment. Each of the operations discussed in the blocks of FIG. 13 were discussed above in further detail.

In block 1303, historical data is received, e.g., periodically, such as index log information associated with the platforms/applications 102. The historical data is associated with a plurality of computing entities. In certain embodiments, the historical data is received at the data indexes/store 144). As is understood, the index log information that is stored in the data indexes/store 144, in certain embodiments, provides historical data associated with transactions and other activities taking place at and/or that are associated with the platforms/applications 102. In block 1305, an inventory self-discovery is performed, e.g., periodically, on all integration platform/application data from all integration platforms, via use of an inventory scheduler 121(block 1310), which was detailed further in the exemplary architecture 100b of FIG. 1B, as discussed above). In block 1315, data for computing entity (e.g., integration platform/application) transactions is tracked, e.g., via the aforementioned transactions scheduler (block 1320), as discussed previously in connection with FIG. 1B and FIG. 4. In at least some embodiments, the data for the computing entity transactions is tracked at least periodically, advantageously using the same time periods as blocks 1303 and 1305, but this is not limiting.

In block 1325, costs are tracked/monitored, e.g., by running the billing scheduler (block 1330), as discussed previously in connection with FIG. 1B and FIG. 5. In block 1335, capex (infrastructure and software licensing) is monitored, as discussed previously. Billing process and total cost data can be determined/generated (block 1340) and the rate card can be updated (block 1345) to compute a cost of each transaction. A database (e.g., database 110) of transaction metrics and cost information is built (block 1347) using the information received, monitored, tracked, and/or generated in blocks 1303-1345. Using the transaction details and data, as described above, an output comprising one or more predictions of transaction volumes can be generated (block 1350), in some embodiments optionally upon request, e.g., via the transaction prediction engine (block 1355), as discussed above in connection with FIGS. 6-11B. In block 1360, an output comprising a transaction cost metrics dashboard/report can be generated, optionally in some embodiments upon request, providing cost management information, including predictions if requested. In block 1365, in some embodiments, an automatic output report/alert is generated, if applicable and/or optionally (e.g., if conditions exist that correspond to the need for the report/alert), where the alert/report indicates that, based on information in the database and/or based on the predictions, actions can/should be taken to optimize and/or lower operations cost.

As the aforementioned description shows, in certain embodiments, the smart asset management framework that is provided (e.g., the system of FIG. 1A and the framework of FIG. 1B) helps to provide a total cost of ownership, to help provide various types of reports, alert, and notifications, to leadership of an organization, about the utilization and cost of integration platforms and applications relating to asset information availability. This enables leaders to make proactive decision based on business needs to optimize resource usage. Advantageously, in at least some embodiments, the smart asset management framework enables an organization to have these features and make these decisions with a single product that is vendor agnostic and which is able to perform analysis on products from many sources.

A further advantage of at least some embodiments herein includes arrangements to leverage a shallow learning approach, including ensemble bagging technique with Random Forest—bootstrap aggregating—approach for predicting the future volume of the transactions. This includes using multiple regressors (this can be done in parallel) each trained on different data samples, and different features. This reduces the variance and the bias stem from using a single classifier. The final regression is achieved by aggregating the predictions that were made by the different regressors.

It is expected that the embodiments herein can be combined with the disclosures in one or more of the following commonly assigned patent publications, which are all hereby incorporated by reference:
U.S. Patent Publication No. 2021/0133594, entitled, “AUGMENTING END-TO-END TRANSACTION VISIBILITY USING ARTIFICIAL INTELLIGENCE,” filed on Oct. 30, 2019 and published on May 6, 2021;
U.S. Patent Publication No. 2022/0076158, entitled, “SYSTEM AND METHOD FOR A SMART ASSET RECOVERY MANAGEMENT FRAMEWORK,” filed on Sep. 9, 2020 and published on Mar. 10, 2022;
U.S. Patent Publication No. 2022/0391832, entitled “ORDER DELIVERY TIME PREDICTION,” filed on Jul. 23, 2021 and published on Dec. 8, 2022; and
U.S. Patent Publication No. 2023/0028266, entitled “PRODUCT RECOMMENDATION TO PROMOTE ASSET RECYCLING,” filed on Jul. 23, 2021 and published on Jan. 26, 2023.

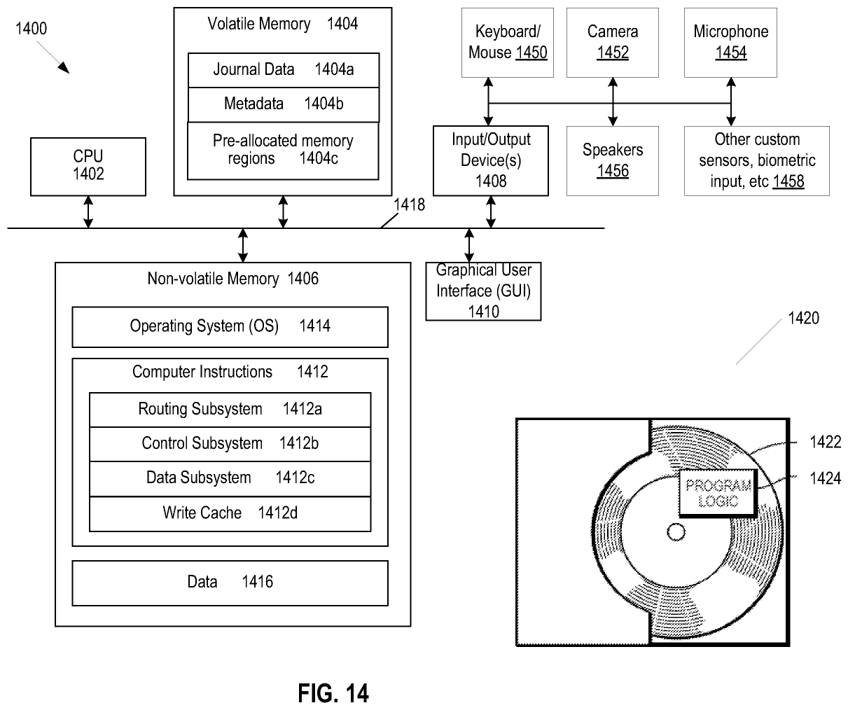

FIG. 14 is a block diagram of an exemplary computer system usable with at least some of the systems, methods, examples, and outputs of FIGS. 1A-13, in accordance with one embodiment. FIG. 14, which shows a block diagram of a computer system 1400 usable with at least some embodiments. The computer system 1400 also can be used to implement all or part of any of the methods, systems, and/or devices described herein.

As shown in FIG. 14, computer system 1400 may include processor/central processing unit (CPU) 1402, volatile memory 1404 (e.g., RAM), non-volatile memory 1406 (e.g., one or more hard disk drives (HDDs), one or more solid state drives (SSDs) such as a flash drive, one or more hybrid magnetic and solid state drives, and/or one or more virtual storage volumes, such as a cloud storage, or a combination of physical storage volumes and virtual storage volumes), graphical user interface (GUI) 1410 (e.g., a touchscreen, a display, and so forth) and input and/or output (I/O) device 1408 (e.g., a mouse/keyboard 1450, a camera 1452, a microphone 1454, speakers 1456 and optionally other custom sensors 1458, providing user input, such as biometric sensors, accelerometers, position sensors, etc.). A bus 1418 interconnects the CPU 1402, volatile memory 1404, non-volatile memory 1406, GUI 1410, I/O devices 1408, speakers 1456, mouse/keyboard 1450, camera 1452 (e.g., webcam), microphone 1454, and/or other custom sensors 1458, as will be understood.

Non-volatile memory 1406 stores, e.g., journal data 1404a, metadata 1404b, and pre-allocated memory regions 1404c. The non-volatile memory, 1406 can include, in some embodiments, an operating system 1414, and computer instructions 1412, and data 1416. In certain embodiments, the non-volatile memory 1406 is configured to be a memory storing instructions that are executed by a processor, such as processor/CPU 1402. In certain embodiments, the computer instructions 1412 are configured to provide several subsystems, including a routing subsystem 1412A, a control subsystem 1412b, a data subsystem 1412c, and a write cache 1412d. In certain embodiments, the computer instructions 1412 are executed by the processor/CPU 1402 out of volatile memory 1404 to implement and/or perform at least a portion of the systems and processes shown in FIGS. 1-13. Program code also may be applied to data entered using an input device or GUI 1410 or received from I/O device 1408.

The systems, architectures, and processes of FIGS. 1A-14 are not limited to use with the hardware and software described and illustrated herein and may find applicability in any computing or processing environment and with any type of machine or set of machines that may be capable of running a computer program and/or of implementing a radar system (including, in some embodiments, software defined radar). The processes described herein may be implemented in hardware, software, or a combination of the two. The logic for carrying out the methods discussed herein may be embodied as part of the system described in FIG. 14. The processes and systems described herein are not limited to the specific embodiments described, nor are they specifically limited to the specific processing order shown. Rather, any of the blocks of the processes may be re-ordered, combined, or removed, performed in parallel or in serial, as necessary, to achieve the results set forth herein.

Processor/CPU 1402 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs). In some embodiments, the “processor” may be embodied in one or more microprocessors with associated program memory. In some embodiments, the “processor” may be embodied in one or more discrete electronic circuits. The “processor” may be analog, digital, or mixed-signal. In some embodiments, the “processor” may be one or more physical processors or one or more “virtual” (e.g., remotely located or “cloud”) processors.

Various functions of circuit elements may also be implemented as processing blocks in a software program. Such software may be employed in, for example, one or more digital signal processors, microcontrollers, or general-purpose computers. Described embodiments may be implemented in hardware, a combination of hardware and software, software, or software in execution by one or more physical or virtual processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid-state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general-purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

For example, when the program code is loaded into and executed by a machine, such as the computer of FIG. 14, the machine becomes an apparatus for practicing one or more of the described embodiments. When implemented on one or more general-purpose processors, the program code combines with such a processor to provide a unique apparatus that operates analogously to specific logic circuits. As such a general-purpose digital machine can be transformed into a special purpose digital machine. FIG. 14 shows Program Logic 1424 embodied on a computer-readable medium 1420 as shown, and wherein the Logic is encoded in computer-executable code thereby forms a Computer Program Product 1422. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiments, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

Throughout the present disclosure, absent a clear indication to the contrary from the context, it should be understood individual elements as described may be singular or plural in number. For example, the terms “circuit” and “circuitry” may include either a single component or a plurality of components, which are either active and/or passive and are connected or otherwise coupled together to provide the described function. Additionally, terms such as “message” and “signal” may refer to one or more currents, one or more voltages, and/or a data signal. Within the drawings, like or related elements have like or related alpha, numeric or alphanumeric designators. Further, while the disclosed embodiments have been discussed in the context of implementations using discrete components, including some components that include one or more integrated circuit chips), the functions of any component or circuit may alternatively be implemented using one or more appropriately programmed processors, depending upon the signal frequencies or data rates to be processed and/or the functions being accomplished.

Similarly, in addition, in the Figures of this application, in some instances, a plurality of system elements may be shown as illustrative of a particular system element, and a single system element or may be shown as illustrative of a plurality of particular system elements. It should be understood that showing a plurality of a particular element is not intended to imply that a system or method implemented in accordance with the disclosure herein must comprise more than one of that element, nor is it intended by illustrating a single element that the any disclosure herein is limited to embodiments having only a single one of that respective elements. In addition, the total number of elements shown for a particular system element is not intended to be limiting; those skilled in the art can recognize that the number of a particular system element can, in some instances, be selected to accommodate the particular user needs.

In describing and illustrating the embodiments herein, in the text and in the figures, specific terminology (e.g., language, phrases, product brands names, etc.) may be used for the sake of clarity. These names are provided by way of example only and are not limiting. The embodiments described herein are not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, elements, circuits, modules, tables, software modules, systems, etc. Such terminology used herein, however, is for the purpose of description and not limitation.

Although the embodiments included herein have been described and pictured in an advantageous form with a certain degree of particularity, it is understood that the present disclosure has been made only by way of example, and that numerous changes in the details of construction and combination and arrangement of parts may be made without departing from the spirit and scope of the described embodiments. Having described and illustrated at least some the principles of the technology with reference to specific implementations, it will be recognized that the technology and embodiments described herein can be implemented in many other, different, forms, and in many different environments. The technology and embodiments disclosed herein can be used in combination with other technologies. In addition, all publications and references cited herein are expressly incorporated herein by reference in their entirety. Individual elements of different embodiments described herein may be combined to form other embodiments not specifically set forth above. Various elements, which are described in the context of a single embodiment, may also be provided separately or in any suitable sub-combination.

What is claimed is:

1. A computer-implemented method, comprising:
receiving, at a first predetermined interval, historical data associated with operation of a plurality of computing entities;
tracking inventory information based on the historical data, the tracking comprising discovering when new computing entities are added to the plurality of computing entities, wherein tracking inventor information place at a second predetermined interval;
tracking transaction information, wherein the tracking is based on the historical data, wherein the transaction information comprises information associated with transactions of the plurality of computing entities and comprises information associated with a volume of transactions, and where the tracking of transaction information takes place at a third predetermined interval;
tracking cost information associated with the transactions of each computing entity, the tracking of cost information taking place at a fourth predetermined interval;
tracking utilization information associated with each computing entity, the utilization information comprising information relating to utilization of an infrastructure of each respective computing entity, the tracking of utilization information taking place at a fifth predetermined interval;
building a database of information for each computing entity, the database comprising at last one of inventory, transaction, and cost information; and
generating an output providing a report of information on one or more computing entities in the plurality of computing entities, wherein the report of information is based on information contained in the database of information.

2. The computer-implemented method of claim 1, wherein at least two of the first predetermined interval, second predetermined interval, third predetermined interval, fourth predetermined interval, and fifth predetermined interval, correspond to time intervals that are identical.

3. The computer-implemented method of claim 1, wherein the second predetermined interval is configured so that inventory information is tracked in real time to ensure that the database of information is up to date.

4. The computer-implemented method of claim 1, wherein the first predetermined interval is configured so that historical data is received before tracking transaction information, tracking cost information, and tracking utilization information.

5. The computer-implemented method of claim 1, wherein the transaction information associated with transactions of the plurality of computing entities comprises at least one of usage, metrics, cost, capital expenses, infrastructure information, licensing information, and operating expenses.

6. The computer-implemented method of claim 1, wherein the report comprises a transaction cost metrics dashboard providing at least one of transaction information, cost information, and utilization information, for at least one computing entity of the plurality of computing entities.

7. The computer-implemented method of claim 1, wherein the report is generated automatically based on information in the database and comprises at least one recommended action to optimize at least one of cost and efficiency associated with operation of at least one computing entity in the plurality of computing entities.

8. The computer-implemented method of claim 1, wherein the report comprises at least one predicted transaction volume associated with at least one computing entity in the plurality of computing entities.

9. The computer-implemented method of claim 8, further comprising:
building a training dataset from a first subset of the historical data;
building a testing dataset from a second subset of the historical data;
performing first training of a machine learning regressor model, with the training dataset, to learn transaction volumes associated with the plurality of computing entities;
performing a second training of the machine learning regressor model, with the testing dataset, to validate the machine learning regressor model; and
generating the predicted transaction volume using the machine learning regressor model.

10. A computer-implemented method, comprising:
receiving historical data associated with operation of a plurality of computing entities;
building a training dataset from a first subset of the historical data;
building a testing dataset from a second subset of the historical data;
performing first training of a machine learning regressor model, with the training dataset, to learn transaction volumes associated with the plurality of computing entities;
performing a second training of the machine learning regressor model, with the testing dataset, to validate the machine learning regressor model; and
predicting a transaction volume for at least one computing entity of the plurality of computing entities using the machine learning regressor model.

11. The computer-implemented method of claim 10, wherein the historical data comprises a plurality of features associated with each of a plurality of transactions and further comprising:
determining in in the plurality of features, a first set of features that are correlated with predicting transaction volume and a second set of features that are irrelevant to predicting transaction volume; and
configuring at least one of the testing dataset and the training dataset to remove points in the respective dataset that correspond to the second set of features.

12. The computer-implemented method of claim 10, wherein the machine learning regressor model is configured using multiple regressors, wherein each of the multiple regressors is trained on different samples of data from the historical data.

13. The computer-implemented method of claim 10, wherein the machine learning regressor model is configured using multiple regressors, wherein each of the multiple regressors is trained on different features of data from the historical data.

14. The computer-implemented method of claim 10, wherein the machine learning regressor model implements a Random Forest regressor structure.

15. The computer-implemented method of claim 10, wherein the machine learning regressor model implements ensemble bagging.

16. A system, comprising:
a processor; and
a non-volatile memory in operable communication with the processor and storing computer program code that when executed on the processor causes the processor to execute a process operable to perform operations of:
receiving, at first predetermined intervals, historical data associated with operation of a plurality of computing entities;
tracking inventory information based on the historical data, the tracking comprising discovering when new computing entities are added to the plurality of computing entities, wherein tracking inventor information place at second predetermined intervals;
tracking transaction information, wherein the tracking is based on the historical data, wherein the transaction information comprises information associated with transactions of the plurality of computing entities and comprises information associated with a volume of transactions, and where the tracking of transaction information takes place at third predetermined intervals;
tracking cost information associated with the transactions of each computing entity, the tracking of cost information taking place at fourth predetermined intervals;
tracking utilization information associated with each computing entity, the utilization information comprising information relating to utilization of an infrastructure of each respective computing entity, the tracking of utilization information taking place at a fifth predetermined interval;
building a database of information for each computing entity, the database comprising at last one of inventory, transaction, and cost information; and
generating an output providing a report of information on one or more computing entities in the plurality of computing entities, wherein the report of information is based on information contained in the database of information.

17. The system of claim 16, wherein the computer program code is further configured, when executed on the processor, to cause the processor to execute a process operable to perform an operation of generating the report automatically based on information in the database, wherein the report comprises at least one recommended action to optimize at least one of cost and efficiency associated with operation of at least one computing entity in the plurality of computing entities.

18. The system of claim 16, wherein the report comprises at least one predicted transaction volume associated with at least one computing entity in the plurality of computing entities.

19. The system of claim 16, wherein the computer program code is further configured, when executed on the processor, to cause the processor to execute a process operable to perform the operations of:
building a training dataset from a first subset of the historical data;
building a testing dataset from a second subset of the historical data;
performing first training of a machine learning regressor model, with the training dataset, to learn transaction volumes associated with the plurality of computing entities;
performing a second training of the machine learning regressor model, with the testing dataset, to validate the machine learning regressor model; and
generating a predicted transaction volume using the machine learning regressor model.

20. The system of claim 19, wherein the machine learning regressor model is configured using multiple regressors, wherein each of the multiple regressors is trained on at least one of different samples of data from the historical data and different features of the data from the historical data.
